(19) United States
(12) Patent Application Publication
(10) Pub. No.: US 2007/0183121 A1
(43) Pub. Date: Aug. 9, 2007

(54) POST PULLER AND METHOD

(76) Inventor: Anthony Futrell, Fairdealing, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/672,291

(22) Filed: Feb. 7, 2007

Related U.S. Application Data
(60) Provisional application No. 60/771,850, filed on Feb. 8, 2006.

(51) Int. Cl. H02B 1/00

(52) U.S. Cl. 361/600

(57) ABSTRACT

A device and method for removing a post. The device includes a housing, at least one stabilizing member and an engagement member. The housing defines a chamber and a lower orifice and is adapted for receiving the post through the lower orifice and into the chamber. The at least one stabilizing member is positioned within the chamber for stabilizing a lateral position of a post received in the chamber. The engagement member is positionable within the chamber and is configured for engaging a portion of the received post within the chamber and biasing the received post against the at least one stabilizing member, responsive, at least in part, to the housing receiving an upward force.

### CROSS-REFERENCE TO RELATED APPLICATIONS

This application claims the benefit of U.S. Provisional Application No. 60/771,850, filed on Feb. 8, 2006. The disclosure of the above application is incorporated herein by reference.

### FIELD

The present disclosure relates to post removal devices and methods and, more specifically, to a new post removal device for removing posts using an auxiliary lifting mechanism.

### BACKGROUND

The statements in this section merely provide background information related to the present disclosure and may not constitute prior art.

Metal fence posts often called “t-posts” or simply “steel posts” are employed in many applications such as on farms, ranches, construction sites and along roadways for fencing, signs and markers. They are relatively easy to install, but sometimes need to be removed.

The use of post removal devices for removing embedded posts are known and consist basically of manually operated leverage device and methods of attaching such manually operated leverage devices to the post to be extracted. Jacks with long handles have been employed to lift fence posts out of the ground. Manual fence post pullers tend to be large and clumsy and offer minimal mechanical advantage. One major problem with known fence post pullers is their inability to grip a fence post that is firmly embedded or that is embedded such that only a minor portion of the fence post is above ground level. In practice, motorized construction equipment is also used to aid in the extraction of the posts. In such cases, it is typical for a working crew to simply wrap a chain around the post and attach the chain to a motorized lifting device such as a tractor or a front-end loader. However, such practice is clumsy, and time consuming and often is dangerous to the working crew.

### SUMMARY

The inventor hereof has succeeded at designing an improved fence puller that can be used for pulling fence posts in a quick and safe operation.

According to one aspect, a device for removing a post. The device includes a housing, at least one stabilizing member and an engagement member. The housing defines a chamber and a lower orifice and is adapted for receiving the post through the lower orifice and into the chamber. The at least one stabilizing member is positioned within the chamber for stabilizing a lateral position of a post received in the chamber. The engagement member is positionable within the chamber and is configured for engaging a portion of the received post within the chamber and biasing the received post against the at least one stabilizing member, responsive, at least in part, to the housing receiving an upward force.

According to another aspect, a device for pulling posts includes a housing defining a lower orifice, an upper orifice, and a chamber having a longitudinal axis extending from the lower orifice to the upper orifice. The housing is adapted for receiving the post through the lower orifice, into the chamber and exiting the upper orifice. A lifting member is fixedly attached to the housing for coupling to a lifting device, receiving the upward force from the lifting device and imparting the received upward force to the housing. Two or more stabilizing members are positioned within the chamber for stabilizing a lateral position of the received post. A pin is positioned within the chamber transverse to the longitudinal axis and is adapted for pivoting about an axis perpendicular to the longitudinal axis of the chamber. A biasing member is attached to the pin for providing a rotational bias to the pin about its axis. An engagement member extends radially from the pin and is configured for biased engagement with a portion of the received post and biasing the post into engagement with the two stabilizing members responsive to the biasing member.

According to yet another aspect, a device for pulling a post includes receiving means for enclosing the post within a chamber of a housing, lifting means for receiving an upward force from a lifting device and imparting the received upward force from the lifting means to the housing, stabilizing means for stabilizing and aligning the position of the post within the chamber, and engaging means for engaging a portion of the post within the chamber and imparting the upward force imparted to the housing to the post.

According to still another aspect, a method for pulling a post includes attaching a lifting device to a housing defining a chamber and receiving the post within the chamber. The method also includes positioning an engagement member against a portion of the post within the chamber and applying an upward force to the housing from the lifting device, wherein the housing, engagement member and stabilizing member cooperate to directly transmit the applied upward force from the housing to the post.

Further aspects of the present invention will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 is front cross-sectional view of a post removal device according to one exemplary embodiment.

FIG. 2A is a side view of the post removal device of FIGS. 1 and 2B according to one exemplary embodiment.

FIG. 2B is top cross-sectional view of the post removal device of FIGS. 1 and 2A without a post within the chamber according to an exemplary embodiment.

FIG. 3 is a side perspective view of a t-post as known in the art.

FIG. 4A is a top cross-sectional view of the post removal device of FIGS. 1, 2A, and 2B with a t-post received within the chamber according to one exemplary embodiment.

FIG. 4B is a side view of the post removal device of FIGS. 1, 2A, 2B, and 4A with a t-post received within the chamber as in FIG. 4A and according to one exemplary embodiment.

It should be understood that throughout the drawings, corresponding reference numerals indicate like or corresponding parts and features.

### DETAILED DESCRIPTION

The following description is merely exemplary in nature and is not intended to limit the present disclosure or the disclosure's applications or uses.

In one embodiment, a device for removing a post includes a housing, at least one stabilizing member and an engagement member. The housing defines a chamber and a lower orifice each of which are adapted for receiving the post to be removed. In some embodiments, the chamber is closed at the end opposing the lower orifice. In such embodiments, the housing and the chamber can have a lengthy elongated body. In other embodiments, an upper orifice opposes the lower orifice and allows for the exiting of a portion of a post received in the chamber. In such embodiments, the housing can take the form of a sleeve that is positionable about the post. Generally, the housing and chamber can define a longitudinal axis along which the post is aligned for receiving.

The housing can be made of any material, including steel or another high strength metal, or a composite. The housing can have a variety of cross-sectional shapes including, by way of example, a square, a rectangle, and a circle. Generally, the housing is adapted for coupling to a lifting device for receiving the upward force. This can include a fixture or feature, such as a hole, that provides for directly attaching a lifting device or machine via a connecting member, such as a hook and chain, between the lifting device and the housing itself. In other embodiments, one or more lifting members can be fixedly attached to the housing for coupling to the lifting device. These lifting members can include one or more bars, hoops or other features that provide for fastening a connecting member to the housing and therefore with a lifting device. Generally, the lifting device is any device or machine that is configured to provide an upward force to the lifting member or directly to the housing. These can include a three-point hitch on a tractor, a front-end loader, a handy man jack, and a hand jack, by way of examples.

The at least one stabilizing member is positioned within the chamber for stabilizing a lateral position of a post received in the chamber. There can be one or more stabilizing members and in some embodiments there are two, by way of example. The stabilizing members can be formed from the housing itself, or can be formed by members that have been positioned in the chamber and fixed to an inner surface of the chamber.

In some embodiments, there are two stabilizing members that are dimensioned and adapted, along with the housing and the engagement member, for receiving a t-post. A t-post is well known and typically has a cross-section of a “T” with a plurality of aligned lugs or projections positioned on the top portion of the “T”. The Lugs are configured for support wire or fencing but can also be engaged to aid in securing the engagement member and the removal device to the post. The stabilizing members can be configured to receive the vertical elongated portion of the t-post cross-section between the two stabilizing members, and provide a surface under the tops of one or both of the upper portions of the “T”. In this positioning, the stabilizing members can secure the t-post in a position relative to the engagement member for enabling the engagement member to engage a lug of the t-post.

As noted the above, the stabilizing member can be formed from a portion of the housing defining the chamber, or can be a shaped insert that is placed or positioned within the chamber to define a preferred shape to the chamber, e.g., creating a sub-chamber or cavity. In one embodiment, the stabilizing member(s) can be configured from a rod that is welded or otherwise attached to an inner wall of the housing that defines the chamber. The stabilizing member can also be configured to aid in the receiving of the post into the chamber by shaping or by extending substantially the length of the chamber. One example, of such beneficial shaping can include the stabilizing member being formed from a contoured rod, such as a rod having an arc shape. Such arc shape rods can be positioned within the chamber such that the arc extends into the chamber mid way between the upper orifice and the lower orifice. Two such contoured rods can be placed on opposing sides of the chamber thereby defining a gap between the two. As both rods have a convex arc shape, the gap between the two is wide at the top and bottom but narrow in the middle, e.g., the gap between the rods has a distance in the middle portion that is less than a distance at a top portion and that is less than a distance at a bottom portion. The contoured gap can aid in receiving the post, such as a t-post, into the chamber, alignment of the t-post within the chamber including alignment of a portion of the post between the stabilizing members and the engagement member.

The engagement member is positionable within the chamber and is configured for engaging a portion of the received post within the chamber and biasing the received post against the at least one stabilizing member, responsive, at least in part, to the housing receiving an upward force.

In some embodiments, the engagement member is configured to be removable from the chamber. For instance, the housing can include an aperture adjacent to a portion of the chamber wherein a wedge, an insert or other device having a cam-like edge can be inserted from outside the housing and positioned within the chamber to engage a portion of the post positioned therein. The inserted engagement member secures the post within the chamber and against the stabilizing member such that an upward force applied to the housing is imparted to the post. The cam-like edge can be configured to bias against the post when the upward force is applied to the housing.

In other embodiments, the engagement member is permanently mounted within the chamber, such as on a pin or other mounting feature. A pin can be positioned within the chamber transverse to the longitudinal axis of the chamber and providing a pivot about an axis of the pin that is perpendicular to the longitudinal axis. The engagement member can be attached to the pin and rotate about the pin axis. For example, in one embodiment, the engagement member can extend perpendicular from the pin (along a radius from the axis). The engagement member can be formed as a tongue or cam like device and extend from the pin into the chamber to be occupied by a received post. The pin can include a user input or interface such as a lever, handle, knob, or otherwise for rotating the pin and therefore the engagement member about the axis and within the chamber. In this manner, the user can manually engage the engagement member through of rotation input to the user interface.

Additionally, a limit feature or member can be incorporated with the pin and/or the engagement member to limit the rotational movement of the engagement member about the axis and within the chamber. In this manner, the limit member can aid in the positioning of the engagement member for ease of engagement and disengagement of the engagement member with a post received within the cavity.

Similarly, a biasing member, such as a spring or other elastic member or device, can be coupled to the pin for rotationally biasing the pin in one radial direction about its axis. This can include elastic or flexible biasing. In such a manner, the biasing member biases the engagement member (attached to the pin) within the chamber in the direction of the biased pin and towards the stabilizing member(s). Additionally, this biasing can elastically bias the engagement member into contact with a fence post received within the chamber. The biasing member can therefore aid in the engagement and disengagement of the engagement member with a post received within the chamber. Additionally, the bias member can provide for securing the post between the engagement member and the stabilizing member(s), thereby securing the housing and entire post removal device to the post. This can provide for improved operation of the removal of the post including improved safety by enabling an operator to attach the removal device to a post, then withdraw to a safe distance during the upward lifting operation of the lifting device. After the post is removed, the biasing member can help to grasp the post between the engagement member and the stabilizing member(s) and hold the post until an operator withdraws the engagement member away from the post such that the post can be removed from the chamber.

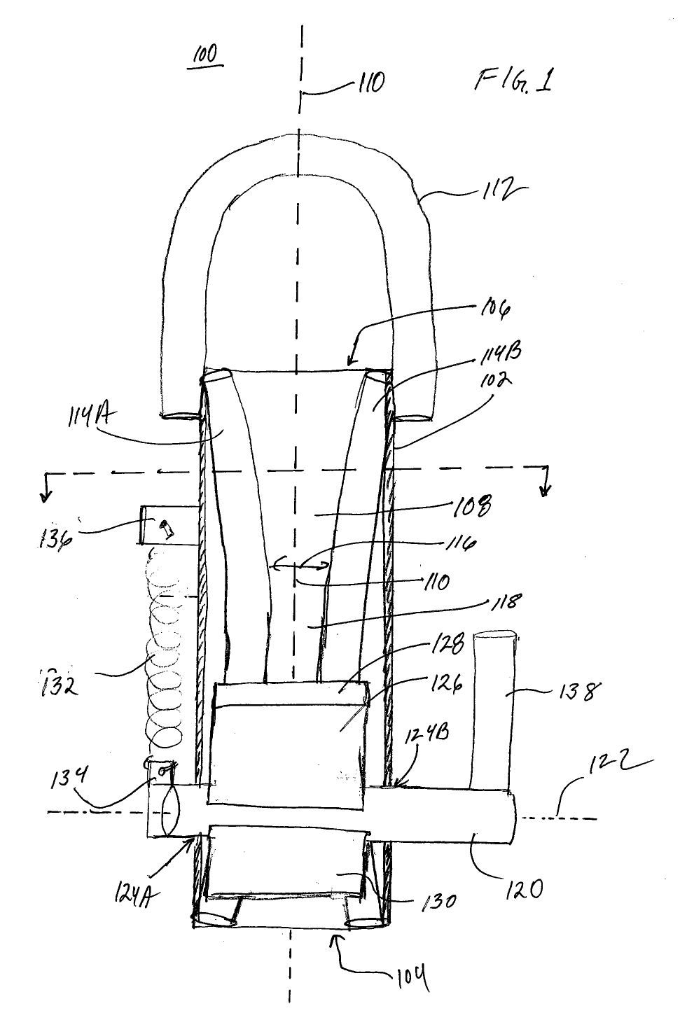

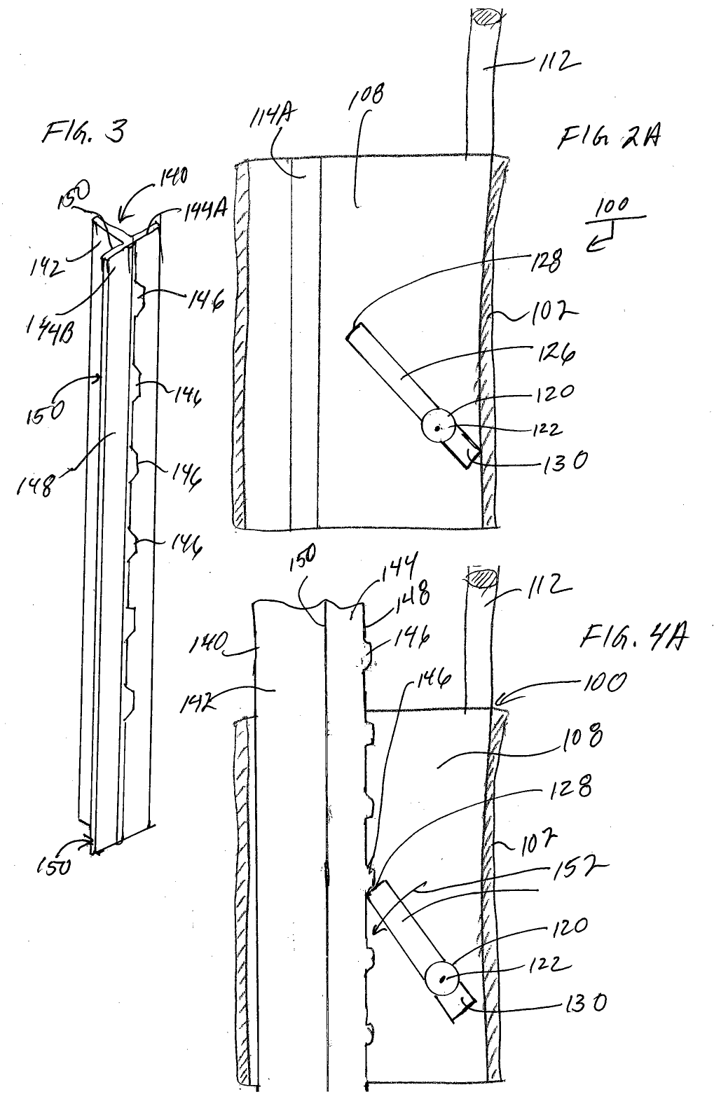

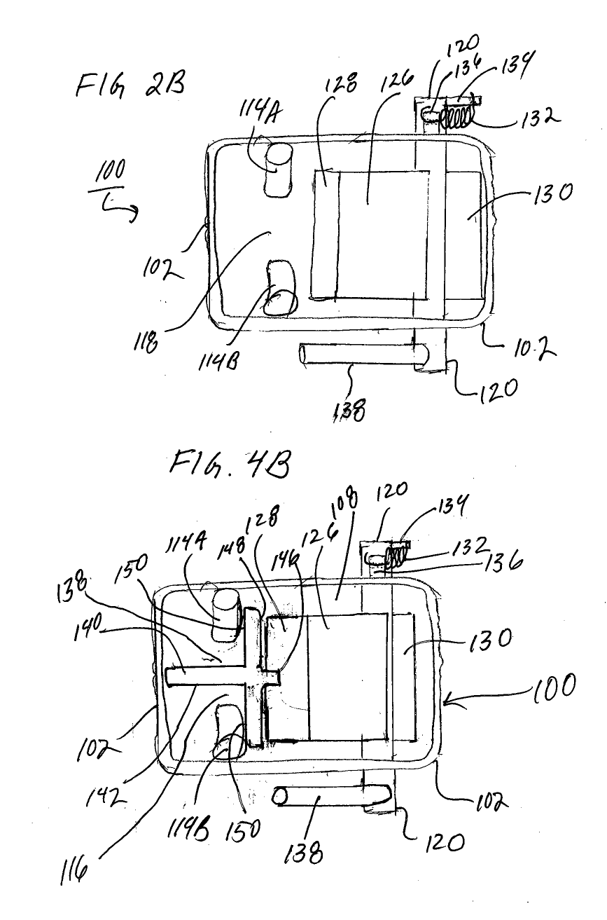

In one exemplary embodiment, as illustrated in FIGS. 1, 2A and 2B, a device 100 for pulling posts includes a housing 102 defining a lower orifice 104, an upper orifice 106, and a chamber 108 having a longitudinal axis 110 extending from the lower orifice 104 to the upper orifice 106. The housing 102 is adapted for receiving a post (not shown) through the lower orifice 104, into the chamber 108 and exiting the upper orifice 106. A lifting member 112, shown in this example as a loop, is fixedly attached to the housing 102 for coupling to a lifting device (not shown). The lifting member 112 can be attached via any method including welding, by way of example where the housing 102 and the lifting member 112 are each made from a metal, such as steel. The lifting member 112 can be shaped to provide for attachment to the lifting device via a hook, chain, or cable, and for receiving the upward force from the lifting device and imparting the received upward force to the housing 102.

Two stabilizing members 114A, 114B are positioned within the chamber 108 for stabilizing a lateral position of the received post. As shown in this example, stabilizing members 114A, 114B can be composed of contoured or curved rods that are welded or otherwise attached to inner surfaces of the housing 102 that define the chamber 108. The stabilizing members 114A, 114B are positioned such the their curves form a gap 116 there between. The gap 116 is dimensioned near the upper orifice 106 and the lower orifice 104 to be wide and is dimensioned near the mid-portion to be narrow. In this manner, the stabilizing members 114A, 114B form, at least in part, a cavity 118 within the chamber 118 that is formed and dimensioned to adapt to the shape of a post to be received and secured within the chamber 108.

A pin 120 is positioned within the chamber transverse to the longitudinal axis 110 and is adapted for pivoting about an axis 122 that is perpendicular to the longitudinal axis 110 of the chamber 108. As shown in this example, the pin 120 extends through holes 124A, 124B is the housing 102 whereby the housing provides for securing the pin 120 while allowing the pin 120 to rotate about axis 122.

An engagement member 126 extends radially from a portion of the pin 120 within the chamber 108. The engagement member 126 is positioned and dimensioned to rotate within the chamber 108 towards the stabilizing members 114A, 114B to engage and secure a post received within the chamber 108. The engagement member 126 can also be composed of a metal such as steel and can be welded or otherwise attached to the pin 120. The engagement member 126 can include an engaging end 128 configured to engage a lug or other feature or projection of a post received within the chamber 108.

A limit member 130 can also be associated with the pin 120 and or the engagement member 126 for limiting the rotational movement of the pin 120 and the engagement member 126 about axis 122. As shown in this example, the limit member 130 can be an extended projection or tab attached to or formed by the pin 122 such as to engage with a portion of the housing 108 to provide the limiting function to the rotation of the pin 120.

A biasing member 132, shown as a spring, is attached to the pin 120 via a radial arm 134 for providing a rotational bias to the pin 120 about its axis 122. The biasing member 132 can also be fixedly mounted to a biasing member mount 136, such as a pin, bolt or screw, or other fastener or feature.

A user interface 138, shown as a handle or lever, can also be connected or attached to the pin 120 such that a user can manually rotate the pin 120 and therefore the engagement member 126 about axis 122. In this manner, the user can withdraw the engagement member 126 in the opposite direction from the biasing force provided by the biasing member 132 to disengage the engagement member 126 and its engaging end 128 from a post for removing the post from the chamber 108.

The engagement member 126, the pin 120, the biasing member 132, and the stabilizing members 114A, 114B are each configured to cooperate to receiving and secure a post within the cavity 108.

A t-post 140 as is known in the art is illustrated in FIG. 3 to aid in the discussion of the use and application of device 100. The t-post 140 has a t-shaped cross-section with an elongated vertical portion 142 and two upper t portions 144A, 144B. A plurality of lugs 146 or projections is positioned vertically along the front face 148 of the top of the t. The upper t-portions 114A, 144B also include underside portions 150, e.g., lower surface 150.

Referring now to FIGS. 4A and 4B, the t-post 140 is positioned within chamber 108 and cavity 138. The elongated vertical portion 142 of the t-post 140 is positioned in gap 116. The upper t-portions 114A, 144B are positioned in the chamber such that the underside portions 150 are proximate to the stabilizing members 114A, 114B, the front face 138 is positioned opposite to the stabilizing members 114A, 114B and towards the engagement member 126. The engaging end 128 of the engagement member 126 is biased with biasing force 152 towards and against the front face 138 to engage lug 146. The user interface 138 can be operated by the user to rotate pin 120 and engagement member 126 in the opposite direction to the biasing force 152 to withdraw the engagement member 126 from the front face 148 and the lug 146. In this manner, the post 140 to be withdrawn from the chamber 108.

As shown, the engaging end 128 engages the post 140 against the stabilizing members 114A, 114B such that an upward movement or force applied to the housing is imparted to the post 140. In this manner, the device 100 can be attached to a lifting device that provides an upward force to the housing 102 for lifting, extracting, or removing a post from an embedded position. The device 100 is easy and quickly attached to a post 140 and easily and quickly removed from the post 140 through operation of the user interface 138.

In operation, one or more embodiments provide for an improved method of pulling a post. In some embodiments, the improved method includes attaching a lifting device to a housing defining a chamber and positioning the housing about the post for receiving the post within the chamber of the housing. An engagement member is positioned against a portion of the post within the chamber, such as to engage a lug or other feature of the post, by way of example. An upward force is applied to the housing from the lifting device and is directly transmitted from the housing to the post. Additionally, the engagement member can be biased against a portion of the post and can be biased such as to bias the post against the stability members or within the chamber. Generally, the housing is positioned to enclose and receive the post in a portion of the chamber that can include a cavity defined, at least in part by the stabilizing members, an interior surface of the housing defining the chamber, and the engagement member. For example, these can be adapted to receive particular post designs such as a t-post having a t-shaped cross-section and a plurality of lugs or other projections. In such embodiments, the engaging of the post can include receiving an elongated vertical portion of the t-post between two or more stabilizing members and positioning the underside of a horizontal portions of top of the t-post against a surface of the stabilizing members and proximate to the engagement member.

As noted above, engagement member can be removed or extracted from its biased position against the post in the direction away from the stabilizing members to enable the removal of the post from the chamber. This can be for repositioning of the removal device on the post or for removing the post following removal or extraction of the post from its embedded position.

Various embodiments of the post removal device as described herein can provide for improved, safe and effect removal of a post from an embedded position. By attaching the post removal device to a three-point hitch or a front loader or another lifting machine or device, via a hook and chain, the post removal device can be easily and quickly installed on a post by an operator. The lifting machine can extract the post and with little effort remove the extracted post from the chamber of the post removal device. The lifting machine can then be moved down a fence line or row for attaching the post removal device to the next post to be removed, thereby providing for efficient and safe post removal operations.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

What is claimed is:

1. A device for removing a post comprising:
a housing defining a chamber and a lower orifice, the housing adapted for receiving the post through the lower orifice and into the chamber;
at least one stabilizing member positioned within the chamber for stabilizing a lateral position of the received post within the chamber; and
an engagement member positionable within the chamber and configured for engaging a portion of the post received within the chamber and biasing the received post against the at least one stabilizing member, responsive, at least in part, to the housing receiving an upward force.

2. The device of claim 1 wherein the housing includes an upper orifice adapted to enable the exiting of an upper portion of the post received within the chamber.

3. The device of claim 1 wherein the housing is adapted for coupling to a lifting device for receiving the upward force.

4. The device of claim 1, further comprising a lifting member fixedly attached to the housing for coupling to a lifting device and configured for receiving the upward force and imparting the received upward force to the housing.

5. The device of claim 1 wherein the chamber defines a longitudinal axis, further comprising a pin positioned within the chamber transverse to the longitudinal axis and adapted for pivoting about an axis perpendicular to the longitudinal axis, the engagement member extending perpendicular from the pin and rotating about the axis of the pin.

6. The device of claim 5, further comprising a biasing member coupled to the pin and configured for rotationally biasing the pin in one direction about axis of the pin and biasing the engagement member towards the at least one stabilizing member.

7. The device of claim 6 wherein the biasing member includes a spring.

8. The device of claim 5 wherein the pin includes a limit member for limiting the rotation of the pin about its axis and restricting the rotation of the engagement member within the chamber.

9. The device of claim 5, further comprising a user interface for receiving an input from a user and imparting a rotation of the pin and the engagement member.

10. The device of claim 1 wherein the at least one stabilizing member includes two stabilizing members configured for receiving a t-post and securing the t-post in a position relative to the engagement member for enabling the engagement member to engage a lug of the t-post.

11. The device of claim 1 wherein the at least one stabilizing member includes a rod attached to a wall of the chamber and extending substantially the length of the chamber.

12. The device of claim 11 wherein the at least one stabilizing member includes two contoured rods positioned on opposing sides of the chamber defining a gap there between, the gap defined by the contours of the rods having a distance in a middle portion that is less than a distance at a top portion and that is less than a distance at a bottom portion.

13. The device of claim 1 wherein the at least one stabilizing member is defined by an inner portion of the housing defining the chamber.

14. A device for pulling posts comprising:
a housing defining a lower orifice, an upper orifice, and a chamber having a longitudinal axis extending from the lower orifice to the upper orifice, the housing adapted for receiving the post through the lower orifice, into the chamber and exiting the upper orifice;
a lifting member fixedly attached to the housing for coupling to a lifting device, receiving the upward force from the lifting device, and imparting the received upward force to the housing;
two or more stabilizing members are positioned within the chamber for stabilizing a lateral position of the received post;
a pin positioned within the chamber transverse to the longitudinal axis, the pin adapted for pivoting about an axis perpendicular to the longitudinal axis of the chamber;
a biasing member attached to pin for providing a rotational bias to the pin about its axis; and
an engagement member extending radially from the pin and configured for biased engagement of a portion of the received post and biasing the post into engagement with the two or more stabilizing members responsive to the biasing member.

15. The device of claim 14, further comprising a limit member for limiting the rotation of the pin about the transverse axis and restricting the rotation of the engagement member within the chamber.

16. The device of claim 14, further comprising a user interface for receiving an input from a user and imparting a rotation of the pin about its axis and against the rotational bias received from the biasing member.

17. The device of claim 14 wherein the two or more stabilizing members are configured for receiving a t-post and securing the t-post in a position relative to the engagement member for enabling the engagement member to engage a lug of the t-post.

18. The device of claim 14 wherein the two or more stabilizing members include two contoured rods positioned on opposing sides of the chamber defining a gap there between, the gap formed by the contour of the rods having a distance in a middle portion that is less than a distance at a top portion and that is less than a distance at a bottom portion.

19. A device for pulling a post comprising
receiving means for enclosing the post within a chamber of a housing;
lifting means for receiving an upward force from a lifting device and imparting the received upward force from the lifting means to the housing;
stabilizing means for stabilizing and aligning the position of the post within the chamber; and
engaging means for engaging a portion of the post within the chamber and imparting the upward force imparted to the housing to the post.

20. A method for pulling a post comprising:
attaching a lifting device to a housing defining a chamber;
receiving the post within the chamber;
positioning an engagement member against a portion of the post within the chamber; and
applying an upward force to the housing from the lifting device, wherein the housing, engagement member and stabilizing member cooperate to directly transmit the applied upward force from the housing to the post.

21. The method of claim 20 wherein positioning the engagement member against the portion of the post includes biasing the engagement member against the portion of the post and biasing the post against a stabilizing member positioned within the chamber.

22. The method of claim 21 wherein enclosing the post within the chamber includes positioning the post in a cavity defined, at least in part, by the stabilizing member and the engagement member.

23. The method of claim 22 wherein the post is a t-post and wherein the cavity is dimensioned to receive an elongated vertical portion of the t-post and a portion of the stabilizing member is configured for contacting an underside of a horizontal portion of top of the t-post.

24. The method of claim 20, further comprising:
removing the engagement member from contacting the portion of the post within the chamber; and
extracting the post from the housing chamber.
